(19) United States
(12) Patent Application Publication
(10) Pub. No.: US 2014/0196567 A1
(43) Pub. Date: Jul. 17, 2014

(54) THE JOHN DEVICE

(71) Applicant: David Woodrow John, Spring Hill, KS (US)

(72) Inventor: David Woodrow John, Spring Hill, KS (US)

(21) Appl. No.: 14/213,837

(22) Filed: Mar. 14, 2014

Related U.S. Application Data
(60) Provisional application No. 61/801,442, filed on Mar. 15, 2013.

(51) Int. Cl. F16F 15/31

(52) U.S. Cl. CPC F16F 15/31
USPC 74/572.1

(57) ABSTRACT

The John Device has the ability to use relatively non-oscillating and linear forces, such as the forces of gravity and its' associated force of buoyancy, permanent and/or electro-magnetism and their forces of attraction and repulsion, and acceleration and its' associated force of deceleration, alone or in combinations, as a motive force to produce useful torque which may then be used for any work requiring torque, and therefore may also be used to generate electricity for any device or machine or system which requires electrical power.

### CROSS REFERENCE TO RELATED APPLICATION

This non-provisional patent application claims the benefit of U.S. Provisional Application 61/801,442, filed on Mar. 15, 2013, titled: DEVICE AND METHOD FOR USING FORCE TO PRODUCE TORQUE AND REDIRECTING RESULTANT TORQUE TO PRODUCE ELECTRICITY OR OTHER FORM OF USEABLE FORCE OR POWER.

### TECHNICAL FIELD

The technical field of this discovery and invention relates to the ability to utilize relatively non-oscillating and linear forces, such as the forces of gravity and its' associated force of buoyancy, permanent and/or electro-magnetism and their forces of attraction and repulsion, and acceleration and its' associated force of deceleration, alone or in combinations, as a motive force to produce useful torque which may then be used for any work requiring torque, and therefore may also be used to generate electricity for any device or machine or system which requires electrical power.

### BACKGROUND OF THE INVENTION

For purposes of understanding and to correlate with the drawings, terminology will be used which is not to be considered limiting. The phrase “torque shaft” refers to and represents a central axis of rotation to which the mass or masses are generally centered around. The torque shaft may be a physical shaft, or a portion of a physical shaft, and may be comprised of any element, material or combinations thereof and may be a component in other systems and devices. The torque shaft may not be a physical shaft, as the connection to the mass or masses may be accomplished through a wide variety of design and manufacturing methods. The terms: “mass”, “masses”, or “mass or masses” refer to the object or objects, fixed or otherwise, which react to the primary motive force, and may be comprised in whole or in part by any elements or materials or combinations of elements or materials, including magnetic and/or electro-magnetic elements and materials, and may also be comprised of all of, or portions of, other devices or machines.

This discovery and invention, hereinafter referred to as: “The John Device”, can utilize forces, such as the forces of gravity and buoyancy, permanent and electro-magnetism, and acceleration and deceleration, alone or in combinations, as a primary motive force to cause a mass or masses to rotate about a central torque shaft to produce useful torque for any device, machine, or system that requires it, and may also be used to generate electricity to power any device, machine, or system that requires it.

The torque shaft is caused to rotate by a secondary motive force, referred to as an: “input drive”, which may be mechanical, electrical, hydraulic, magnetic, or any other force, device, or system. The torque shaft, not being at exactly zero or ninety degrees in relation to the forces imposed, creates a continuously variable plane of rotation being presented to the mass or masses. As the plane rotates, the mass or masses react due to the forces involved. For example, in a gravity-only based system, the mass or masses are pulled downward by the Earth's gravity, and being connected to the torque shaft are unable to fall directly, causing the torque shaft to rotate. As the mass or masses fall, the torque shaft, or the plane, has moved again, and the mass or masses will again attempt to fall towards the Earth, with this cycle continuing endlessly as long as an input drive presents a continuously variable rotating plane to the torque shaft.

The torque shaft may then be directly connected to any other device or mechanism which uses torque, or converts torque to other types of force or power, one example being the torque shaft on an electrical generator to provide electrical power.

The John Device is infinitely adaptable and scalable, with examples of similar devices on a macro scale being planets and their precession, and on a micro scale, atomic elements and their structure and spin. Research and testing on working examples of The John Device have shown remarkably similar characteristics to these phenomena, ranging from, but not limited to, the angles of the torque shaft in relation to the overall structure of the system, pivot point connection angles to the torque shaft, locations of mass, and the effects of various speeds and mass structures on the system.

### SUMMARY

### Technical Problem

The ability to use a relatively non-oscillating and linear or one-directional force or forces as a primary motive force to produce rotational torque or electricity has long been an area of research and invention. The force of gravity, its' associated force of buoyancy, and the force of magnetism or electromagnetism are relatively radial or circular in nature, but often present as relatively linear or flat. For example, because of the size of the Earth, when an object is on the surface of the planet, the force of gravity appears linear and one-directional, causing an ‘up’ and ‘down’ relationship. Magnets, in many situations and uses, also may exhibit linear forces of attraction and repulsion. The force of acceleration and its' associated force of deceleration can also be considered as relatively linear.

Previous systems have been specifically designed so that when they are considered perpendicular to a force, their torque shaft or center of rotation is oriented or aligned at exactly zero or ninety degrees from the orientation of the force, depending on interpretation. In addition, numerous systems take specific steps to ensure this exact zero or ninety degree, or perpendicular alignment of the shaft in relation to forces.

Some previous systems have been designed to allow an offset from zero or ninety degrees, and have attempted to devise methods to utilize inertia and plane manipulation for force, but then ensure the re-alignment of their torque shaft to zero or ninety degrees at some point within the construct of their machine, thus defeating the potential gained.

It is generally known that misalignment of the torque shaft can have a negative impact for a variety of well known mechanical and engineering reasons, and engineers and inventors have devised numerous methods to ensure what is considered a proper zero or ninety degree alignment in relation to force imposed.

Some other previous systems have used a torque shaft that is not at zero or ninety degrees and may have an unbalanced mass or variation thereof with a proposed method to rotate said mass, but have failed to place a connection to the torque shaft in direct alignment and connection with the electrical generating system or other system requiring torque, and therefore are unable to overcome problems of friction at mounting points as mass increases and other design problems negating any potential gains necessary to produce useful torque.

A common problem associated with previous systems that rely on forces, such as the force of gravity, as a primary motive force is that they typically lack adaptability of design and structure and cannot manage or accept changes in mass, structure, speed, and other factors, and thus are unable to produce the torque required to produce useful output.

Although many systems have attempted to produce useful torque, using one or more of the forces of gravity, magnetism, and acceleration, a common problem is that the systems do not connect directly or indirectly to the torque shaft for output to a device that requires torque as input.

Also, a common problem for previous systems that attempt to use a relatively linear and non-oscillating force such as gravity and others discussed here is that the systems will slow down over a period of time, usually due to mechanical losses such as friction, because they are not specifically driven systems. Not being controlled and driven, other systems also lack the ability to operate over a wide variety of speeds.

### Solution to Problem

In one embodiment presented, The John Device can use the force of gravity as the primary motive power, and an input drive to drive a torque shaft to which an unbalanced mass is connected, which may then be connected to an electrical generator to create useful electrical output. Due to the continuously variable rotating plane presented to the torque shaft, the system functions on the principle of energy gain caused by mass or masses falling under the influence of gravity in a closed system that is permanently maintained in a state of dynamic imbalance with an input, continuous or not, of external energy. Gravity is only one force The John Device can utilize, and the same principle of dynamic imbalance or equilibrium applies to all the forces and combinations thereof.

In empirical testing of a working example of a gravity-only based system, The John Device has been documented and observed to consume not more than 5 Watts of power on the input drive motor, while producing in excess of 2000 Watts of shaft torque. Current limitations of the materials, construction, and mass available to the inventor restrict results. For example, this particular embodiment is constructed out of plywood, 2×4s plumbing pipe, and handmade wooden toothed pulleys. The technology inherent in The John Device no limitations on designs, structures, actual sizes or uses, and can be implemented as either a very small, micro solution or a very large, macro solution and may encompass any size and scale in between.

### Advantageous Effects of Invention

The John Device overcomes the problems with previous systems in that it can accept a wide range of torque shaft angles relative to forces and can utilize any size and type of mass or masses, as in various embodiments, the mass may be distributed in any structure or design across the entire horizontal plane to produce the desired imbalance, and will then produce the related torque said mass or masses being driven at a speed desired to produce useful output, is scalable to any size, micro-scale to macro-scale, and is only limited by present day manufacturing and construction constraints.

The torque shaft may connect directly or indirectly to a device that utilizes torque, and this allows The John Device to overcome problems with previous systems, allowing a wide range of devices to be directly or indirectly connected.

The John Device is a controlled and driven system, and therefore does not slow down or change speed over time due to losses in friction, gravitational pull, or other forces, unless mandated to do so by the system operator.

### BRIEF DESCRIPTION OF DRAWINGS

In order to have a better understanding of The John Device, reference is to be made to the accompanying drawings. It is to be understood that The John Device is not limited to the precise arrangements shown in the drawings. For example, a specific separate motor for starting the system is not shown due to the relatively small mass used for this embodiment, but may be used in other implementations of The John Device, as the input drive used to maintain the appropriate speed does not necessarily require the full torque capability required to overcome forces and start a large mass from a stop and accelerate it to operational speed. Although the direction of force is not specifically indicated in the drawings, its' understanding is anticipated. The John Device is specifically responsive to force, so it also must be aligned to that force. Because The John Device can be designed and implemented in limitless ways, there will be limitless methods to align the subsequent systems designed by future inventors. Also, specific implementations regarding torque or electrical connection to a particular device or system are not displayed as there are limitless devices and systems that can utilize this technology. Input power for the input drive is not specifically displayed, as it may be derived from any source, external or internal to the system in which it is installed, and may include its' own storage capabilities to allow self-starting of the system, as it may or may not be independent of other system storage and/or power generation capabilities.

FIG. 1 is an isometric view of a working example of The John Device depicting the production of useful torque using two opposed masses at varying pivot point angles and at varying distances from a central primary torque shaft, being driven through continuously rotating planes by an input drive motor located on the top of the device and a gear multiplier and generator located below the device;

FIG. 2 is a side view of a working example of The John Device shown in FIG. 1;

FIG. 3 is a side view of a working example of The John Device with a gear multiplier and generator located on the top of the device and the input drive located below the device;

FIG. 4 is an elevated side view of a prophetic example of The John Device;

FIG. 5 is an elevated side view of a prophetic example of The John Device displaying different pivot point sin(0) angles of attachment to the torque shaft;

FIG. 6 is a elevated side view of a prophetic example of The John Device displaying magnetic enhancement;

FIG. 7 is a side view of a prophetic example of various elements of The John Device and also displays a mass structure without a complete central shaft, yet still displaying the element of a torque shaft or center of rotation;

FIG. 8 is a side view of a prophetic example displaying variations in overall mass and system structure and design;

FIG. 9 is a side view of a working example of The John Device displaying an opposing pair of masses, located on opposite sides of the primary torque shaft;

FIG. 10 is a side view of a working example of The John Device displaying a device that utilizes torque connected to the primary torque shaft by an offset multiplier device, such as a pulley and belt arrangement or chain and sprocket or gears;

FIG. 11 is a side view of a working example of The John Device displaying an alternate view of the torque shaft in FIG. 10, showing the approximate travel of the torque shaft in this embodiment, which also displays connection to an offset multiplier device;

FIG. 12 is side view of a working example of The John Device, displaying multiple opposing pairs of masses, located on opposite sides of the torque shaft;

FIG. 13 is a side view of a working example of The John Device displaying a single mass, located on one side of the primary torque shaft;

FIG. 14 is a side view of a working example of The John Device displaying a single or multiple masses, which may move inwards towards the torque shaft, or outwards away from the torque shaft, to cause an appropriate decrease or increase in resultant torque;

FIG. 15 is a side view of a working example of The John Device displaying a single or multiple masses, which may or may not be mounted on variable angle arms, which may move in an upward direction, and consequently inwards towards the torque shaft, or may move in a downward direction, and subsequently outwards away from the torque shaft, to cause an appropriate decrease or increase in resultant torque;

FIG. 16 is a side view of a working example of The John Device displaying a mass completely enclosing the torque shaft;

FIG. 17 is a side view of a prophetic example of The John Device displaying the input drive motor or mechanism being moved to a location underneath the mass and removing the upper restraining portion of the mounting frame or chassis;

FIG. 18 is a side view of a prophetic example of The John Device displaying the use of the force of magnetism by the use of magnets at different locations to replace, enhance, or diminish the force of gravity or the force of acceleration and their associated forces;

FIG. 19 is a view of a prophetic example of The John Device displaying the use of the force of acceleration or the force of gravity by placing The John Device in an apparatus such as a Gimbal, allowing it to be continually oriented in relation to the forces of said acceleration and/or gravity.

FIG. 20 is a close-up partial view of a working example of The John Device input drive motor assembly.

### DESCRIPTION OF EMBODIMENTS

As required, detailed embodiments of the present invention are disclosed herein: however, it is to be understood that the disclosed embodiments are merely exemplary of the invention, which may be embodied in various forms. Various embodiments shown may share the characteristics, abilities, and benefits of other embodiments in any combination. Therefore, specific structural and functional details disclosed herein are not to be interpreted as limiting, but merely as a basis for the future claims and as a representative basis for teaching one skilled in the art to variously employ the present invention in virtually any appropriately detailed structure. The John Device is infinitely scalable and adaptable to various materials and methods of manufacture and design, with limitless applications, and will therefore take shape in limitless implementations.

Each embodiment will teach the principle of having a torque shaft or center of rotation that is not exactly zero or ninety degrees in relation to the forces and is misaligned intentionally so that the forces involved can act on the mass, while the input drive creates a continually variable rotating plane, thus causing the mass to be attracted or repulsed from the force, endlessly turning a torque shaft in response to said force while attempting to achieve a state of equilibrium.

Terminology will be used in the following description for convenience in reference only and will not be limiting. For example, the words “top” and “bottom” refer to the upper and lower portions of The John Device, respectively, but the forces involved are of a locally linear nature, and therefore many structures, characteristics, and methods related to this discovery and invention have the ability to be reversed in their orientation to said force with anticipated design changes. The “frame” is a mechanism that supports the system and ultimately assists in constraining the torque shaft and allow for a continuously variable rotating plane, but the torque shaft may be constrained by another method utilizing external frames or supports or portions thereof suitable to achieve the same result.

The John Device will be described with references to the drawings forming a part of the present application. Throughout the various figures, similar elements are numbered accordingly. In each case, the descriptions of the elements and objects used are not to be limiting, but simply to aid in teaching one skilled in the art to variously employ the present invention in virtually any appropriately detailed structure.

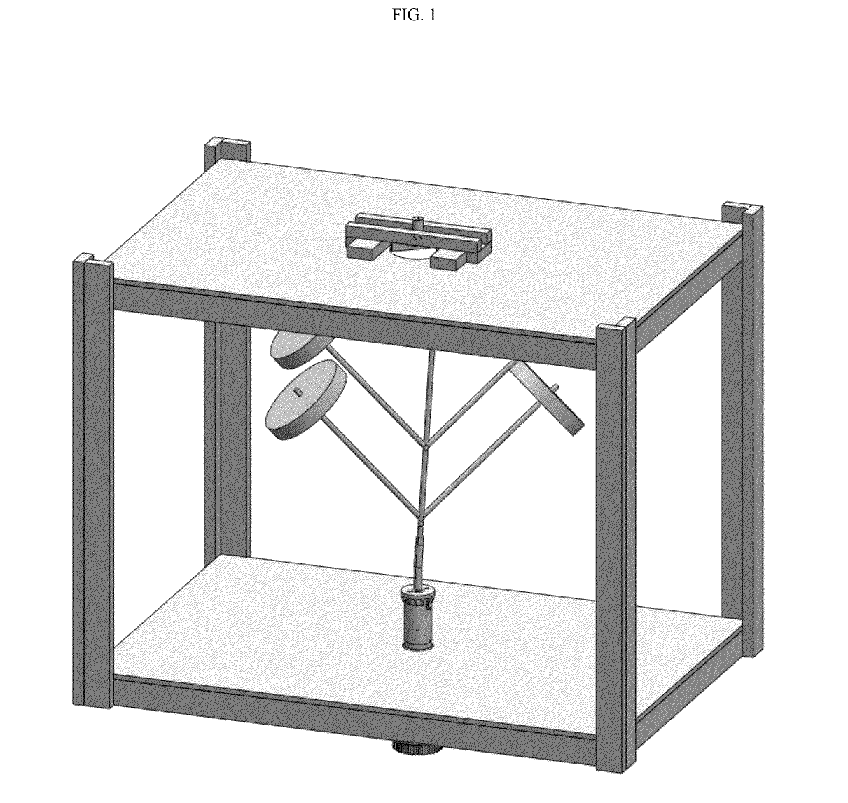

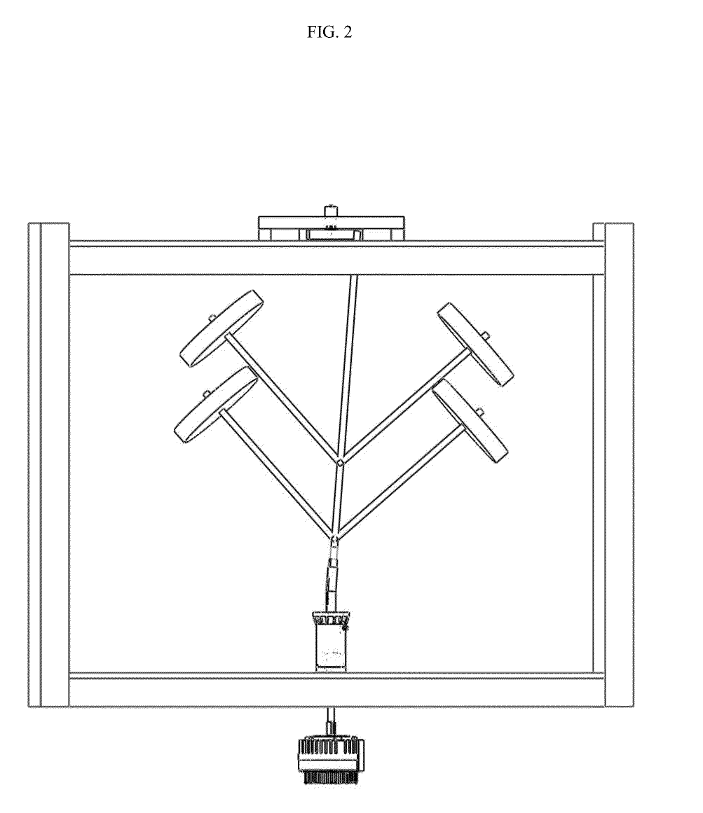

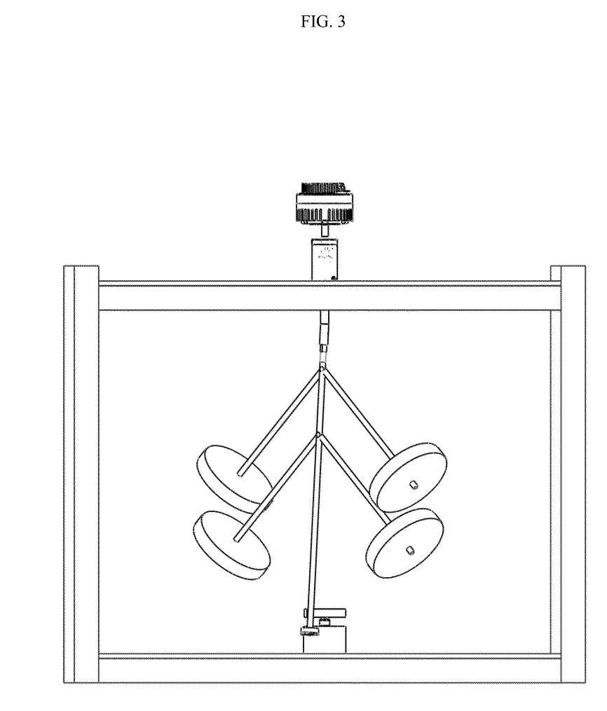

In order to gain a better understanding of the embodiments of The John Device shown in FIG. 1, FIG. 2, and FIG. 3, the overall dimensions are approximately 6 feet in length by 4 feet in width by 4 feet in height. The size was selected because it is a standard size of pre-cut plywood which was estimated to be strong and large enough to form the base and top for a model to empirically test, evaluate, and demonstrate The John Device. The primary torque shaft is approximately 3 feet in length, and the arms connecting the masses to the primary torque shaft create a circle with a diameter that is approximately 4 feet. The top of the frame has an opening that allows for the primary torque shaft to be caused to rotate by the input drive which produces a continuously variable rotating plane to be presented to the mass or masses. The method used allows the torque shaft or plane to be rotated without using a direct twisting motion to cause the rotation, but instead, guiding the torque shaft around the circumference of the top frame opening in a circular or hypocycloid motion. This allows for the torque shaft to be on a continuously variable rotating plane. This rotating plane can follow the pattern of a circle, in which the mass falls through a large number of small events, or in hypocycloidal patterns, which reduce the number of events. For example, a working example of The John Device has an input drive and mechanism which creates an approximate deltoid (triangular) pattern for the torque shaft to follow, directing the masses through three events in a single rotation instead of as many as the thousands that can be found in a circular pattern. To describe the effect, the masses fall a greater distance attempting to achieve equilibrium when following a hypocycloidal pattern, and the pattern must be optimized for the masses and forces concerned. Empirical testing has shown that a deltoid or triangular pattern may be the optimum pattern for the rotation of the plane of the torque shaft.

FIG. 2 displays an embodiment in which a gear multiplier is connected to an electrical generator mounted below The John Device, and FIG. 3 displays an embodiment in which a gear multiplier and electrical generator is mounted above The John Device. These embodiments display the ability to directly connect to an electrical generator to produce electricity in any amount required for any situation. A gear reducer or multiplier and an electrical generator, shown as separate units may well be combined into a single unit, or a generator may be optimized to run at the particular frequency that a particular system requires.

FIG. 4 displays an embodiment with a modified frame to fit the circular nature of The John Device. This embodiment also displays rotation of over 16,000 (sixteen thousand) pounds of mass.

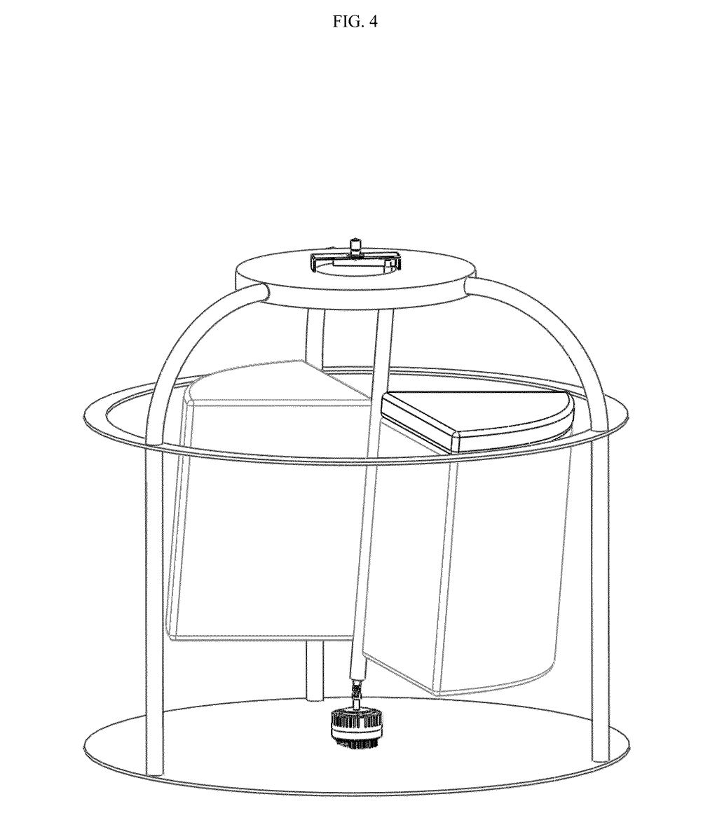

FIG. 5 displays an embodiment showing enhanced pivot point connection angles and mass distribution in relation to the torque shaft. This embodiment visually displays the similarity to the natural phenomena of atomic spin and planetary precession.

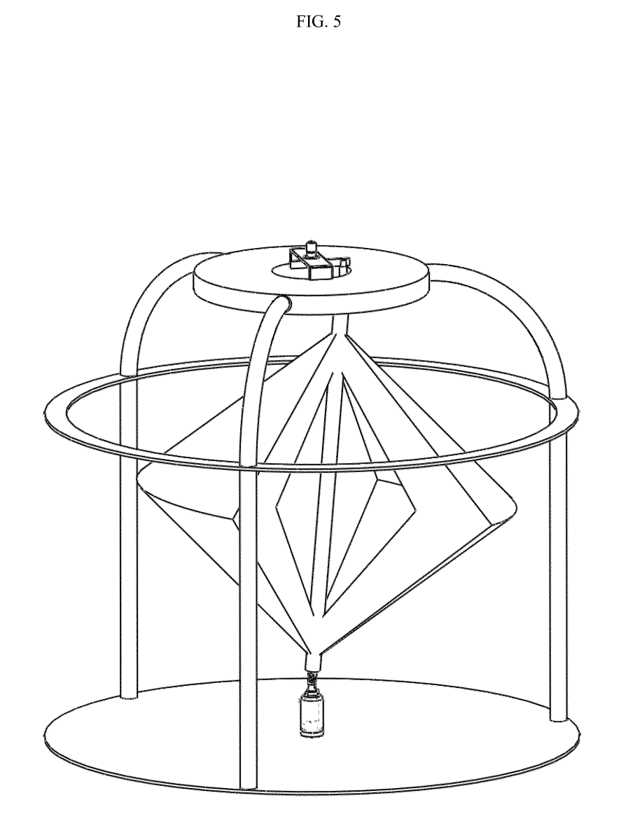

FIG. 6 displays an embodiment in which a large ring magnet has been added below the masses. This highlights the ability of The John Device to use more than one force concurrently, as the magnetic attractive force will add to the force of gravity, creating additional force.

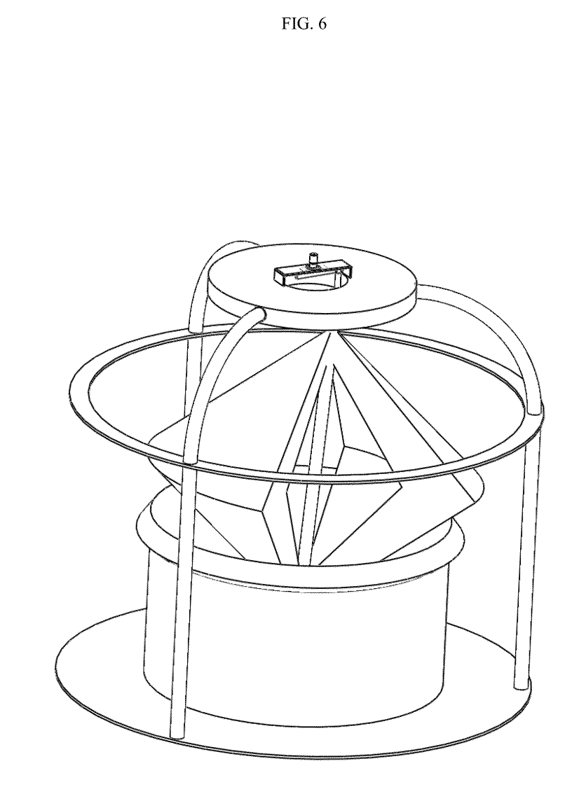

FIG. 7 displays an elements of embodiment in which the physical central torque shaft has been virtually eliminated, but still displays the concept of a central axis of revolution. This figure displays several important aspects relating to this embodiment of The John Device, those being a direct connection to an electrical generator, the ability for the mass to rotate at an angle other than zero or ninety degrees depending on orientation, the ability to rotate in a circular or other fashion similar to hypocycloidal motion creating unique planes during rotation, and having an input drive.

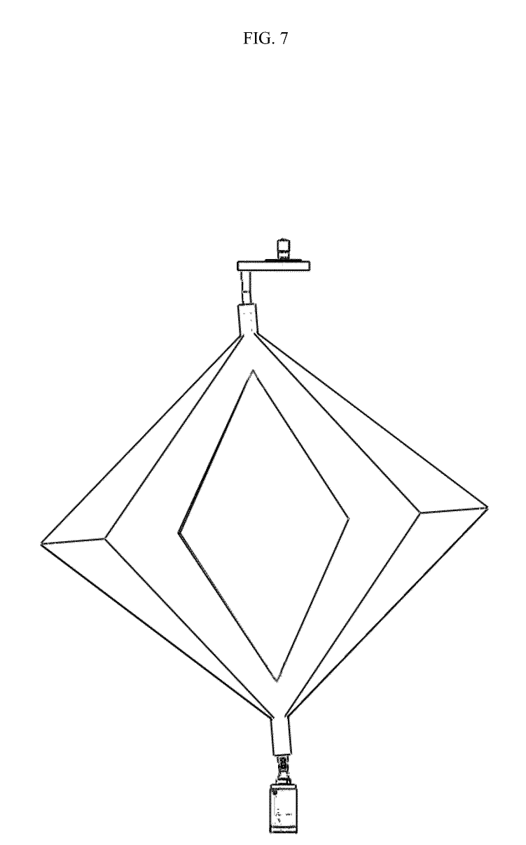

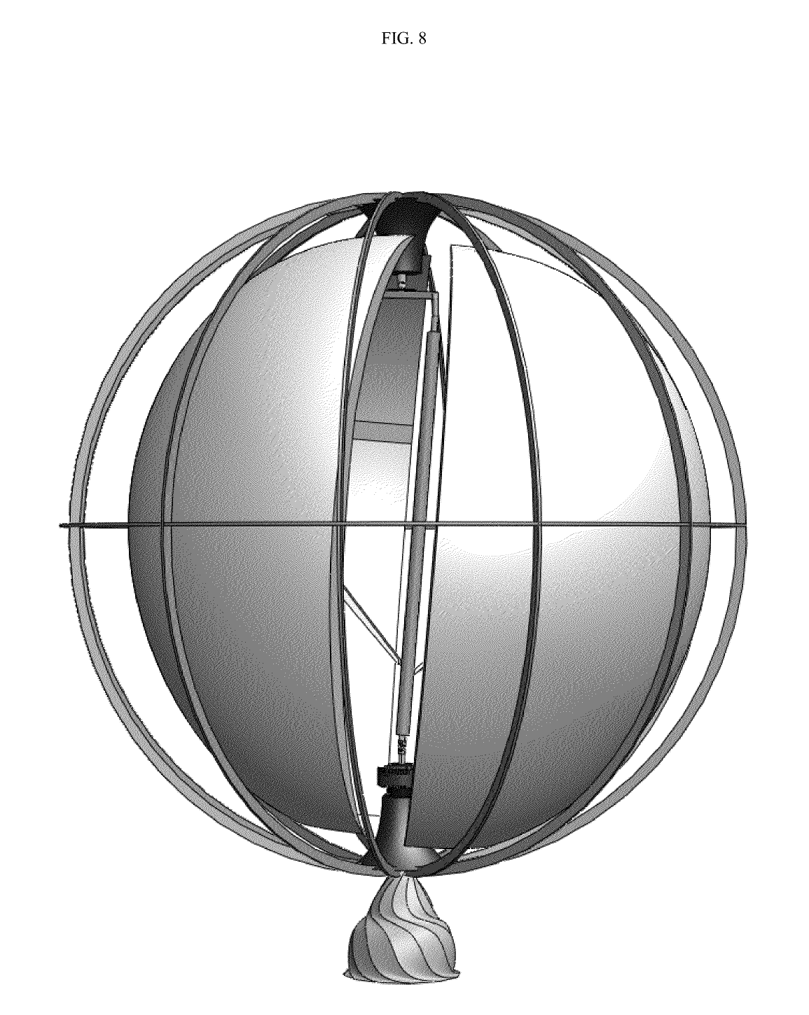

In order to highlight understanding that The John Device technology can tolerate a wide variety of configurations, FIG. 8 displays an embodiment with the curving masses encompassing virtually the entire internal mechanism.

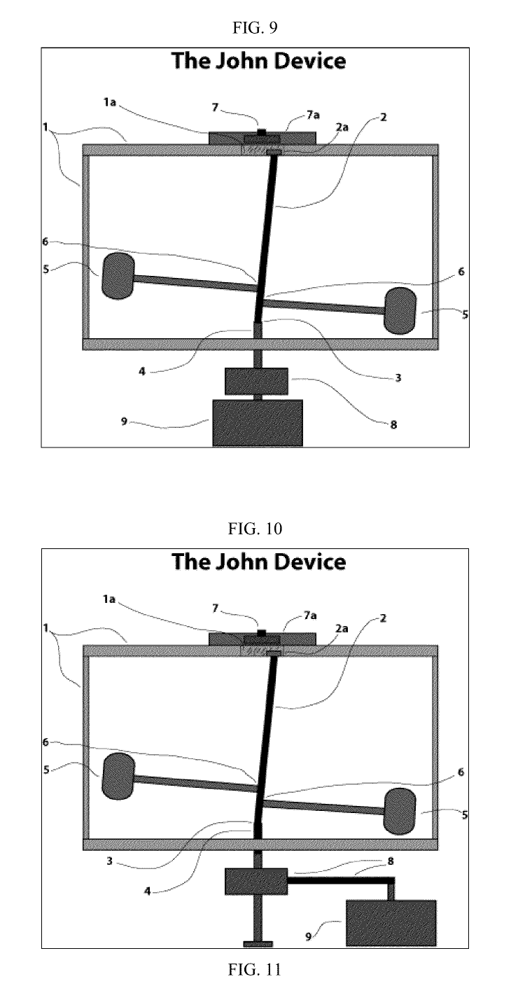

In the embodiment of The John Device shown in FIG. 9, the frame 1 of the system gives support to the base structure and the top of the frame 1 has an opening 1a for the top of the torque shaft 2. The masses 5 are connected to the torque shaft 2 at the pivot points 6. The torque shaft 2 is connected 3 to the secondary torque shaft 4 that will be connected to a multiplier device 8 if required, and to an electrical generator or other device requiring rotary torque 9. The top of the torque shaft is a freely rotating mechanism 2a that is driven by the top input motor assembly 7 which is held in place by the top input motor carrier 7a, through the area of the top opening 1a, following a circular or hypocycloid pattern, which causes the plane supporting the unbalanced mass to be continually variable and rotate, allowing the mass to ‘fall’ in relation to a force, such as gravity, seeking equilibrium. As the mass attempts to achieve equilibrium, the plane of the torque shaft moves to the next plane through an almost infinite number of planes throughout the three hundred sixty degree rotation of a circle, being driven or controlled to drive to the desired speed by the input drive motor assembly 7. As the masses 5 are ultimately being driven to rotate by the input drive motor assembly 7, the resultant torque produced on the torque shaft 2 and subsequently available to the secondary torque shaft 4 can drive a multiplier device 8 if required, and an electrical generator or other device requiring rotary torque 9. The amount of useful torque produced can be scientifically calculated using the accepted formulas for torque and Watts, and is related to the amount of mass used, the distance from the primary torque shaft 2 of the mass used, the angle on the pivot point connecting the mass, and the rotational speed at which the mass is driven.

FIG. 10 and FIG. 11 show an embodiment of The John Device in which the electrical generator or device requiring rotary torque 9 has been moved to a secondary location not directly connected to the primary or secondary torque shaft, but connected to a multiplier device 8. In this embodiment, an electrical generator is connected via a pulley to a pulley mounted on the secondary torque shaft 3 and directly connected to the torque shaft 2. FIG. 11 is shown to provide a visual example of the approximate ‘left’ travel of the torque shaft 2 during rotation. The torque shaft 2 rotates through a circle, proscribed by the diameter of the top opening 1a and the top torque shaft connection 2a, so in actuality there is no ‘left’ or ‘right’ side of the device, per se, in relation to the rotation of the torque shaft 2.

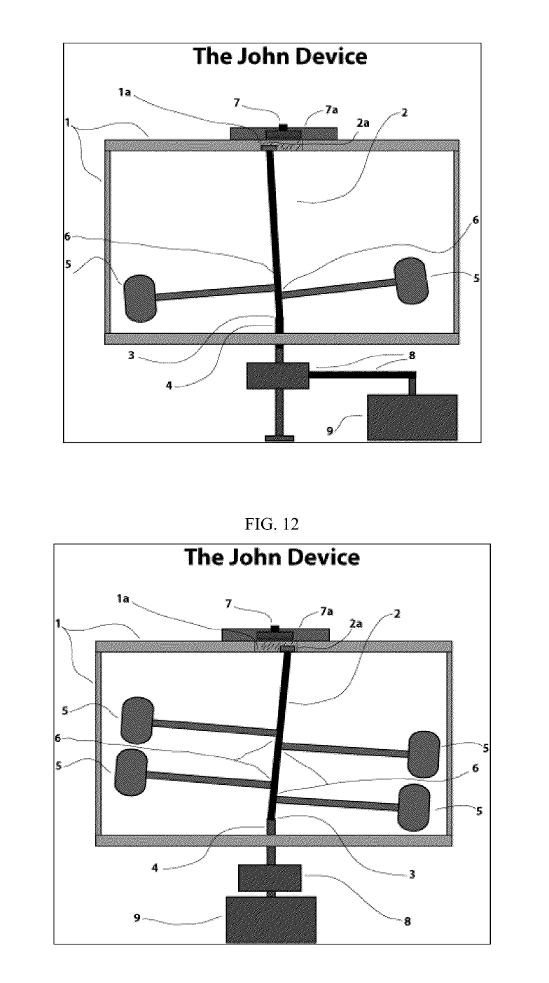

FIG. 12 shows an embodiment of The John Device in which multiple masses 5 have been added to the system and connected to the torque shaft 2. The John Device is tolerant of an endless amount of mass 5 while still being driven by a small amount of power from the input drive motor assembly 7, because the mass 5 that is rotating on the torque shaft 2 is largely balanced. In actual practice, The John Device is highly tolerant of a wide variety of mass or masses 5 and configurations, and can accept changes in mass 5 and variations in angle and distance while powered off or while still in operation.

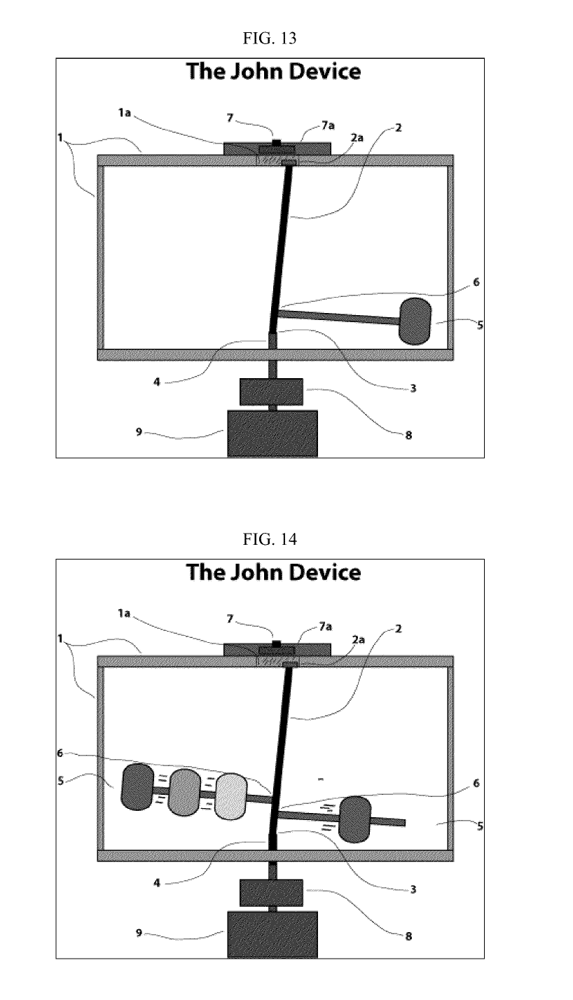

The initial testing of The John Device was performed using the one-armed embodiment shown in FIG. 13 in which a single mass 5 is shown. This embodiment displays the ability to tolerate a variety of mass 5 and the structure of such mass 5 in relation to the torque shaft 2.

Moving the mass 5 closer to the torque shaft 2 diminishes the amount of resulting torque if all other factors are equal. The embodiment in FIG. 14 shows mass 5 moving along the connections to the torque shaft 2. The John Device may have mass 5 that move independently of the speed of the system when in operation. The ability to have adjustable mass 5 allows The John Device to produce additional torque as required, and may assist in startup, within the design limits of the physical structure relating to mass, distance, angle, and speed. The configuration of the adjustable mass 5 is not to be limiting and may be in any configuration and be comprised of any element, material, or combinations.

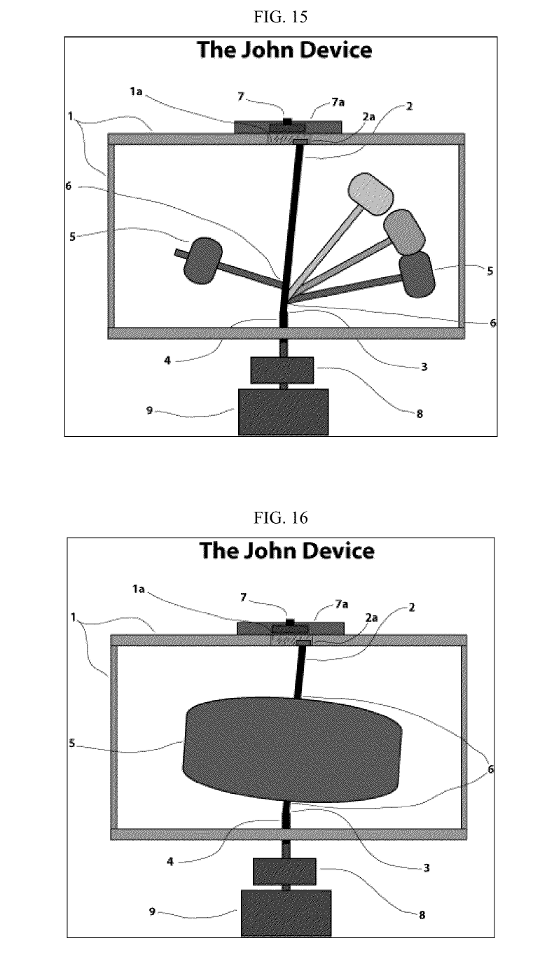

The adaptability and flexibility of The John Device is shown on the embodiment in FIG. 15 in which the mass or masses 5 are located at different pivot point 6 angles in relation to the torque shaft 2. The ability to have adjustable pivot point 6 angles allows The John Device to produce additional torque as required, and may assist in startup, within the design limits of the physical structure relating to mass, distance, angle, and speed. The configuration of the adjustable pivot point 6 angles is not to be limiting but simply illustrative.

FIG. 16 shows an embodiment of The John Device in which a single mass 5 may encompass the torque shaft 2. The pivot points 6 are along the entire length of the mass 5 where it connects to the torque shaft 2, and the embodiment would produce as much torque as required within the design limits of the physical structure relating to mass, distance, angle, and speed. This further highlights the ability of The John Device to adapt to a virtually limitless variety of mass or masses 5, with limitless atomic and molecular structures, compositions, features, abilities, and benefits thereto.

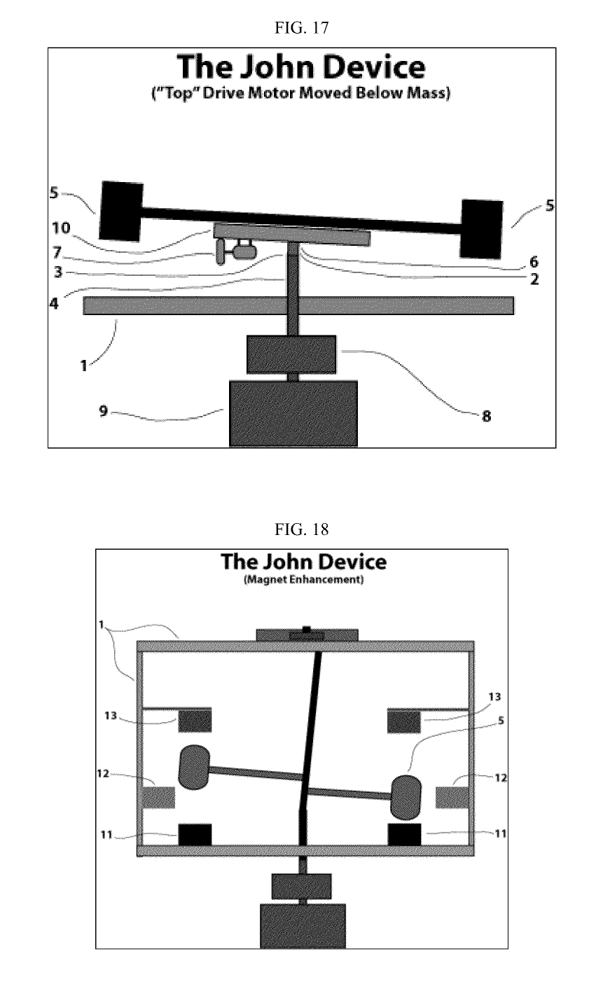

By replicating the angle produced on the torque shaft 2 and locating it under the mass 5 with a retaining method 10; and re-locating the input drive assembly 7 to a location under the mass 5 or retaining method 10, The John Device may be structured and operated using a smaller frame 1 that does not enclose the mass 5, and is shown in an embodiment in FIG. 17. It is to be understood that all the variations relating to different embodiments of The John Device can also be implemented using this embodiment with a lower input motor assembly 7, and with all the advantages thereto.

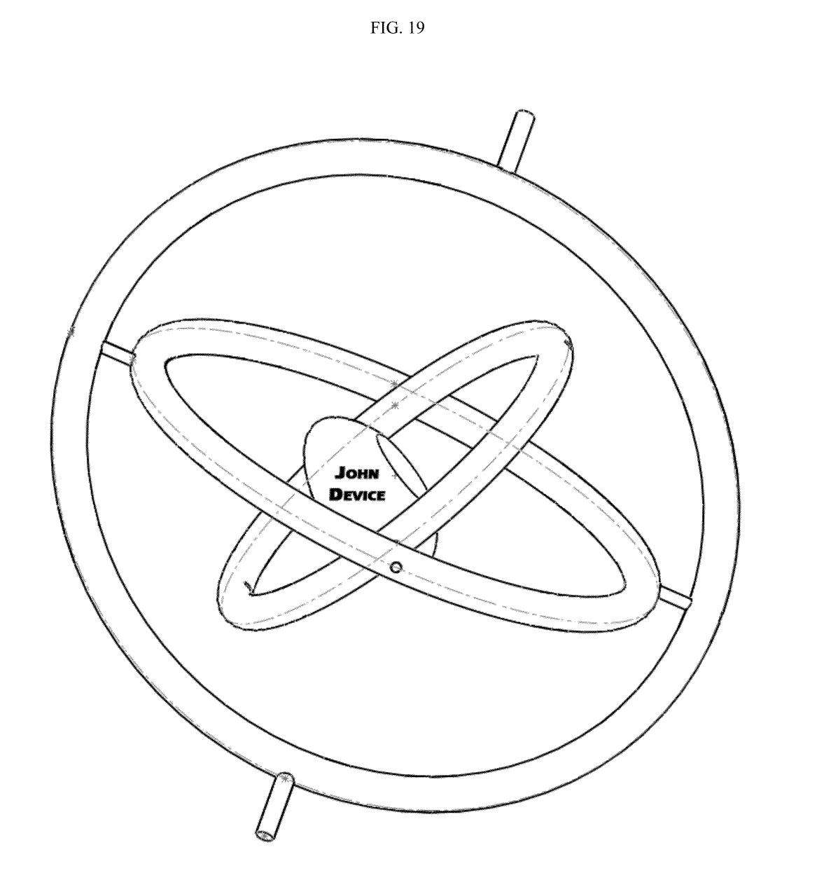

Utilizing magnetic elements 11 and/or 12 and/or 13 in conjunction with an embodiment of The John Device shown in FIG. 18 gives the ability to enhance and/or replace the force of gravity and/or the force of acceleration. The elements defined as mass 5 and the magnetic elements 11 and/or 12 and/or 13 may be constructed of ferromagnetic materials, magnets, permanent magnets, or electromagnetic elements and/or electromagnetic devices. In various embodiments, the magnetic elements 11 and/or 12 and/or 13 may exhibit attracting or repelling forces in relation to mass 5; or mass 5 may exhibit attracting or repelling forces in relation to magnetic elements 11 and/or 12 and/or 13. In this embodiment of The John Device, the frame 1 is comprised of non-magnetic materials, but may comprise any type of material suitable for a particular design or application.

In any embodiment of The John Device, it may be desirable to allow the system to alter its' orientation in response to forces, typically those caused by gravity or acceleration, in order to maintain the orientation of the device in relation to the force or forces. The John Device is shown in FIG. 19 mounted in a Gimbal-type device that allows for rotation in any direction. The apparatus shown is not to be limiting, and is only shown as a prophetic example to present that The John Device has the ability to be designed and constructed to be mounted in any position, and can be continually re-oriented to the forces involved in order to produce useful torque. This ability would include any stationary or mobile object, device, or system, including, but not limited to, stationary devices, portable or mobile devices, and land, water, air, or space based objects and vehicles or locations requiring either electrical power or useable torque. The multi-dimensional rotational ability of such a Gimbal apparatus, in part or in whole, or other such apparatus can be used to locate any embodiment of The John Device in relation to the force of gravity and/or magnetism and/or the force of acceleration to adjust for design and installation requirements, issues or other constraints or concerns. It is anticipated that a wide variety of mounting platforms and other structures that may include forms of leveling or self-leveling will be integrated with future inventions that utilize the technology of The John Device, both for stationary and mobile implementations.

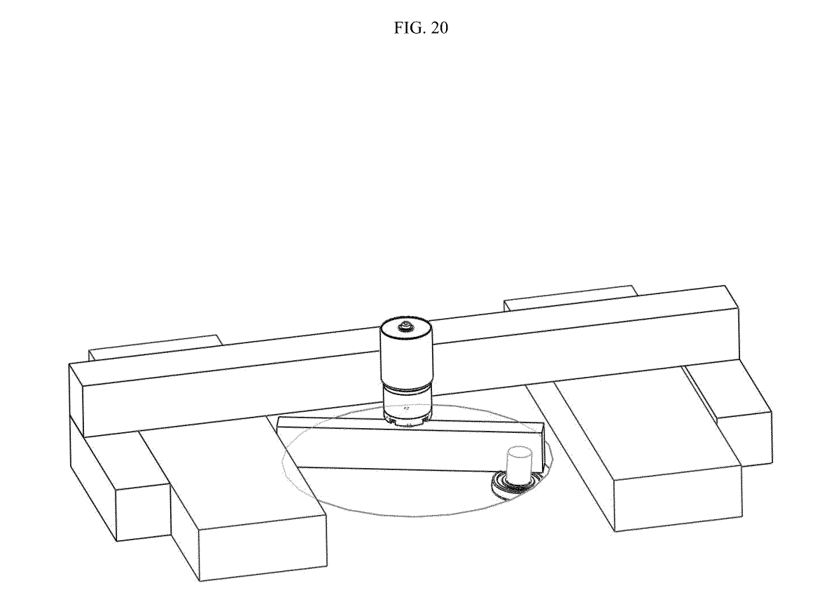

In order to assist in understanding the input drive system on a working example of The John Device, FIG. 20 is a close-up partial view is shown with a crossbar that would be nearest to the viewer removed for clarity. The torque shaft is shown with a bearing arrangement to facilitate ease of movement around the circular cut out. The drive motor, which on one working example of The John Device is a 12 VDC, 0.35 Amp-4.2 Watt electrical motor, rotates a connected bar which subsequently exerts force against the torque shaft, causing a continuously variable rotating plane to be presented to the mass or masses.

### CITATION LIST

### Patent Literature

U.S. Provisional application: 61/801,442, filed Mar. 15, 2013.

### Non Patent Literature

There are extensive videos showing several embodiments in operation available on the Internet which were entirely created and published to the Internet by the Inventor, David Woodrow John. These videos show some of the working examples, setups and variations described and allowed for in these patent documents.
www.youtube.com/user/davidwjohn
www.facebook.com/thejohndevice
www.thejohn device.com

1. A force driven motor, that utilizes relatively linear and non-oscillating forces, such as those of gravity, magnetism, and acceleration, to produce torque for any work, including work required to drive an electrical generator system, comprising:
a torque shaft and mass or masses as described herein, not aligned at zero or ninety degrees in relation to a force;
an input drive as described herein to cause the torque shaft to present a continuously variable plane of rotation to the mass or masses;
a connection to a device requiring torque,
wherein the mass or masses interact with the force or combinations of forces and attempt to reach a state of equilibrium which is prevented by the torque shaft being driven to provide a continuously variable rotating plane, forcing the mass or masses to continue to seek a state of equilibrium, subsequently turning the torque shaft, which may be directly connected to any device that requires torque, and may also be directly connected to an electrical generator or ratio multiplier or reducer and then a generator as necessary for any application.

2. The force driven motor of claim 1, wherein a frame, or support mechanism provides support for the elements comprising the system.

3. The force driven motor of claim 1, wherein the planes presented to the torque shaft through three hundred sixty degrees of rotation are circular in nature.

4. The force driven motor of claim 1, wherein the planes presented to the torque shaft through three hundred sixty degrees of rotation are deltoid or triangular in nature, causing three planes to be presented to the torque shaft per rotation.

5. The force driven motor of claim 1, wherein the planes presented to the torque shaft through three hundred sixty degrees of rotation are created by a hypocycloid motion and may comprise any shape and nature thereof.

6. The force driven motor of claim 1, wherein the system has the elements of an electrical generation system and direct connection thereto attached in order to produce electrical current for any device which requires it.

7. The force driven motor of claim 1, wherein the system has the ability to be connected to an electrical power grid, home, business, device, machine, or any other object or system which requires or can utilize electrical current.

8. The force driven motor of claim 1, wherein the system utilizes a self-contained energy storage system, which may derive input power from any source, to provide power for the input drive.

9. The force driven motor of claim 1, wherein the system utilizes shared energy storage, which may derive its' input power from any source, to provide power for the input drive.

10. The force driven motor of claim 1, wherein the system may utilize permanent magnets to create, enhance, or diminish force.

11. The force driven motor of claim 1, wherein the system may utilize electro-magnets to create, enhance, or diminish force.

12. The force driven motor of claim 1, wherein the system is mounted in such a way as to enable the utilization of the force of acceleration.

13. The force driven motor of claim 1, wherein combinations of forces may be utilized to produce torque and/or electricity for stationary or mobile devices, mechanisms, systems, or any other object which requires it.
